(19) United States
(12) Patent Application Publication
(10) Pub. No.: US 2024/0391832 A1
(43) Pub. Date: Nov. 28, 2024

(54) STRENGTH ENHANCING ADMIXTURE FOR LOW-CARBON CEMENTITOUS COMPOSITIONS

(71) Applicant: MAPEI S.P.A., Milano (IT)

(72) Inventors: Giorgio Ferrari, Milano (IT); Fabio Castiglioni, Milano (IT); Piero Corbo, Milano (IT); Marco Squinzi, Milano (IT)

(73) Assignee: MAPEI S.P.A., Milano (IT)

(21) Appl. No.: 18/578,042

(22) PCT Filed: Jul. 11, 2022
(86) PCT No.: PCT/EP2022/069329

§ 371 Date: Jan. 10, 2024

(30) Foreign Application Priority Data
Jul. 12, 2021 (EP) 21184949.2

(51) Int. Cl. C04B 22/00; C04B 22/08; C04B 22/14; C04B 24/02; C04B 24/06; C04B 24/10; C04B 24/12; C04B 28/02; C04B 40/00; C04B 103/00; C04B 103/14; C04B 103/40; C04B 111/00

(52) U.S. Cl. CPC C04B 22/00867; C04B 22/085; C04B 22/142; C04B 24/02; C04B 24/06; C04B 24/10; C04B 24/122; C04B 28/02; C04B 40/0039; C04B 2103/0012; C04B 2103/0014; C04B 2103/0016; C04B 2103/0018; C04B 2103/0025; C04B 2103/0088; C04B 2103/14; C04B 2103/408; C04B 2111/00017

(57) ABSTRACT

The invention relates to a new concrete admixture based on metal silicate hydrates and ettringite for improving the strength development at both early and longer ages of low-carbon cementitious compositions based on Portland cement and supplementary cementitious materials SCMs, including fly ash, slag, natural pozzolans, silica fume, calcined clays and fillers, such as limestone powder.

### BRIEF DESCRIPTION OF THE INVENTION

The present invention relates to a new concrete admixture based on metal silicate hydrates and ettringite for improving the strength development at both early and longer ages of low-carbon cementitious compositions based on Portland cement and supplementary cementitious materials SCMs, including fly ash, slag, natural pozzolans, silica fume, calcined clays and fillers, such as limestone powder.

### BACKGROUND OF THE INVENTION

Concrete, with an annual production of more than 10 billion cubic meters, is the second most used material on earth, after water. Its success arises from its versatility, resilience, ease of production, low cost and durability. The essential ingredient of concrete is Portland cement, the “glue” which, after mixing with water and setting, binds together the other ingredients, represented by sand and coarse aggregates.

Besides these advantages, the production of concrete poses alarming environmental concerns for the massive CO₂ emissions associated with its production, large part of which is ascribed to the key input Portland cement. In fact, the chemical and thermal combustion process involved in the production of cement are a large source of CO₂, accounting for around 8 percent of global CO₂ emissions (Lehne, J. and Preston, F., “Making Concrete Change—Innovation in Low-carbon Cement and Concrete”, Chatham House report, the Royal Institute of International Affairs, 2018).

The replacement of Portland cement by Supplementary Cementitious Materials (SCMs) such as fly ash, Ground Granulated Blast-Furnace Slag (GGBFS), pozzolanas, calcined clays and the addition of fillers such as ground limestone represent the powerful levers for reducing the use of cement and correspondingly the CO₂ emissions. In some cases, particularly with GGBFS, the replacement in Portland cements can be up to 80 percent, as for example in cement CEM III/B according to European Norm EN 197-1, which contains from 66 to 80 percent of GGBFS as clinker substitute.

One of the most important limitations to high substitution levels of clinker by SCMs in Portland cement is the loss of strength of the resulting concrete, compared with similar concrete made with only Portland cement. Indeed, SCMs react slower than clinker and therefore develop mechanical strength after longer time. Furthermore, also the final strength at longer age is lower when the amount of SCMs exceed certain dosage. For these reasons, the actual global average level of substitution of SCMs in commercial cements, expressed as the clinker-to-cement ratio, remains stationary around 0.71, still far from the ambitious target of 0.60 for “low-carbon” cementitious compositions to reach the carbon neutrality by 2050 and to comply with 2-degree Celsius (° C.) Scenario 2DS (International Energy Agency IEA, “Technology Roadmap—Low-Carbon Transition in the Cement Industry”, The Cement Sustainability Initiative, 2018).

The need to reduce the clinker-to-cement ratio to the desired values for the carbon neutrality have actively stimulated the research for new chemical admixtures to solve both the problems of early and final strength development of low clinker, low-carbon, cementitious compositions.

U.S. Pat. No. 4,318,744 discloses an admixture composition for improving the strength of Portland cement concrete containing pozzolan, comprising a mixture containing at least one component selected from lignosulfonic acids, hydroxylated carboxylic acids, glucose polymers, alkanolamines, sodium chloride, sodium nitrite, calcium nitrite, formic acid.

U.S. Pat. No. 5,084,103 discloses an improved hydraulic Portland cement composition comprising a Portland cement having at least 4 percent C₄AF in combination with at least one higher trialkanolamine selected from triisopropanolamine, N,N-bis(2-hydroxyethyl)-N-(2-hydroxypropyl)amine, tris(2-hydroxybutyl)amine and their mixtures.

WO 2015/062798 discloses an admixture composition for improving the properties of the cementitious composition wherein the admixture composition comprises at least a polycarboxylate type comb-polymer dispersant and a hydroxyl amine compound selected from N,N-bis-(2-hydroxypropyl)-N-(hydroxyethyl)amine and optionally one or more polyhydroxyalkyl ethyleneamine compounds.

WO 2017/214108 describes a cement admixture for cementitious compositions based on glycol ether acetates, particularly including 2-butoxyethyl acetate and 2,2-(butoxyethoxy)ethyl acetate. By adding such admixture at the dosage of 1 percent by weight of cement, the compressive strength of the resulting mortar is increased by 12 percent after 7 days of curing, compared to the same mortar without the admixture.

In recent years, new generation admixtures have been proposed to promote the early strength development of Portland cement. Such new additives are based on water suspensions of nano-sized particles of calcium silicate hydrates and transition metal silicate hydrates and confirmed to be a very effective and risk-free technology to accelerate the hydration rate of clinker-based cements. Thanks to the reduced setting time and early development of mechanical strength, such new generation admixtures represent a promising way to extend the future use of concrete with lower amount of clinker and higher amount of SCMs. A comprehensive description of the mechanism of action and properties of this new generation of accelerating admixtures is included in Chapter 10 “Nanoseeds as modifiers of the cement hydration kinetics” of the book “Smart Nanoconcretes and Cement-based Materials”, edited by M. S. Liev, P. Nguyen-Tri, T. A. Nguyen and S. Kakooei (Elsevier, 2020).

EP 2664596 discloses a process for the preparation of such accelerating admixtures by reacting a water-soluble calcium compound with a water-soluble silicate compound in the presence of an aqueous solution containing a water-soluble comb polymer suitable as plasticizer for hydraulic binder. Such composition consists of a dispersion of nano-sized particles of calcium silicate hydrate in water stabilized by the water-soluble comb polymer. However, calcium silicate hydrate crystal nuclei as nano-sized particles tend to agglomerate due to their large specific surface area, and their efficiency as hardening accelerators tends to be significantly reduced with time as the size becomes larger and the long-term dispersion stability of the calcium silicate hydrate crystal nucleus suspension is difficult to be ensured.

CN 111253107 claims an alcohol amine modified hydrated calcium silicate early strength agent which solves the problem of long-term dispersion stability of a hydrated calcium silicate crystal nano-sized suspensions, preventing the agglomeration of nano-sized calcium silicate nuclei in larger agglomerates, the stabilizing agent being an alcohol amine selected from the group of triethanolamine, diethanolamine, dimethylethanolamine, triisopropanolamine, isopropanolamine, diisopropanolamine, diethanolmonoisopropanolamine and monoethanoldiisopropanolamine.

EP 3080052 claims the use of transition metal silicate hydrate and mixed transition metal alkaline earth metals silicate hydrate, in the form of particles with diameter lower than 1000 nm, as accelerating admixture for hydraulic binders. Typical transition metals include chromium (Cr), manganese (Mn), iron (Fe), cobalt (Co), nickel (Ni), copper (Cu) and zinc (Zn). The structure of nanoparticles claimed in EP 3080052 B1, based on copper-doped calcium silicate hydrate, has been recently determined by Dal Sasso G. et al. (Nanomaterials, 2022, 12, 342, https://doi.org/10.3390/nano12030342) as consisting of covalent silicate tetrahedra chains linked to octahedra calcium atoms with covalent bonding of copper atoms in the external part of the structure.

Recently, other mineral phases in the form of water suspensions have been employed as early age strength accelerators. In particular ettringite, a typical hydration product of Portland cement hydration, has been shown to be an effective early-age accelerator when added to cementitious mixtures.

Lo Presti A. et al. (Proceedings of the 12th International Congress on the Chemistry of Cement, Montreal, T1-04.3, Canada, 2007) first studied the synthesis of aqueous suspensions of ettringite by reaction of a water-soluble calcium compound with a water-soluble aluminum compound, a water-soluble sulfate compound and a water-soluble hydroxide ions source in the presence of a water-soluble comb-like copolymer suitable as a superplasticizer for cementitious mixtures.

WO 2015/028402 described a method for producing a strength enhancing admixture based on an aqueous suspension of calcium silicate hydrates nanoparticles and ettringite stabilized by water soluble comb-like superplasticizer. The admixture has been shown to accelerate the early-age strength development of a limestone-blended cement when added at 6.7% by weight of cement.

Yu J. et al. (2019, Construction and Building Materials, 207, 249-257) claimed that ettringite seeds are able to strongly promote the early age strength development of calcium sulfoaluminates cement pastes.

Nevertheless, even if the abovementioned admixtures based on calcium silicate hydrates, transition metal silicate hydrates and ettringite described in EP 2664596, EP 3080052, WO 2015/028402 and in the paper from Yu S. et al. (2019) improve the early strength development of low-carbon cementitious compositions rich in SCMs, they do not give substantial improvements in enhancing the final strength at longer age.

US 2019/0367422 describes a strength enhancing admixture for cementitious and/or pozzolanic compositions based on calcium silicate hydrate, obtained from the reaction of a water-soluble calcium compound with a water-soluble silicate compound in the presence of a water-soluble dispersant. This admixture is based on the formulation of at least the afore mentioned calcium silicate hydrate, at least an alkanolamine, at least an inorganic accelerating admixture and at least a carbohydrate. This admixture composition enhances the final strength of cementitious compositions without affecting the early strength development.

### DESCRIPTION OF THE INVENTION

The present invention concerns an admixture for producing low clinker, low-carbon cementitious compositions. More particularly, one of the objects of the invention is a strength enhancing admixture capable of developing high final strength of cementitious composition with reduced amount of clinker and high dosages of supplementary cementitious materials, such as fly ash, ground granulated blast furnace slag, natural pozzolans, limestone, calcined clays and fillers, such as finely ground limestone. Another object of the invention is a strength enhancing admixture capable of developing high final strength of such cementitious compositions without affecting the development of early strength.

Another object of the invention is a cementitious composition comprising at least one cementitious material, selected from hydraulic cements and mixtures of hydraulic cements with supplementary cementitious materials, and the strength enhancing admixtures of the invention.

The strength enhancing admixture of the invention comprises a) transition metal silicate hydrates, b) synthetic ettringite, in the form of aqueous suspensions stabilized by water soluble dispersants and not obtained from cement hydration, c) at least one alkanolamine, d) at least one hydroxylated organic compound.

The enhancing admixture may optionally comprise one or more inorganic accelerators.

Suitable transition metal silicate hydrates are disclosed in EP 3080052, characterized by the following general formula:

aMeₓO_{y}·bMO·cAl₂O₃·SiO₂·dH₂O 1)

wherein
Me represents a transition metal whose molar coefficient a is in a range between 0.001 and 2, preferably between 0.01 and 1;
M represents an alkaline earth metal whose molar coefficient b is in a range between 0 and 2, preferably between 0.3 and 1.6;
the molar coefficient c for Al₂O₃ is in a range between 0 and 2, preferably between 0.1 and 1;
H₂O represents the hydration water of the silicate hydrate whose molar coefficient d can vary within a wide range between 0.5 and 20;
x and y can both be equal to 1 or different, depending on the valence of the transition metal, given that the valence of the oxygen atom in the metal oxide is equal to 2.

The transition metal silicate hydrates are those described in EP 3080052 and can be synthesized by combining, under high shear mechanical treatment, a soluble silicon-containing compound, a soluble transition metal compound and possibly a soluble compound of an alkaline earth metal and/or aluminium, in alkaline conditions, to form an aqueous suspension of transition metal silicate hydrate of formula 1) with final particles of size lower than 1000 nm, said process being carried out in the presence of a water-soluble dispersant. Suitable water-soluble dispersants are: polyethercarboxylate polymers, possibly containing phosphonic and/or sulfonic groups, and phosphonate derivatives of polyoxyalkylenes.

Preferred polyetherpolycarboxylate polymers are those described in EP 1547986, consisting in crosslinked or partially crosslinked polyetherpolycarboxylate polymers. Such polymers, useful as intrinsically low-foaming superplasticizers, comprise ter-polymers of the following mixtures of monomers having the following formulas:

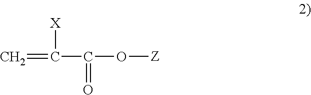

where Z=H, Na, Li, ½ Ca and X is H or CH₃;

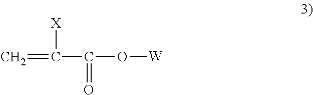

where W=—(—CH₂—CH₂—O—)ₙ—CH₃, n is integer from 51 and 300 and X is H or CH₃;

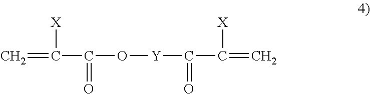

where

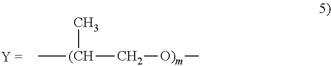

and m is integer from 2 to 50.

In another preferred embodiment, the polyetherpolycarboxylate polymers are those described in EP 2516344, obtained by reacting at temperature from 140° C. to 180° C. and distilling water off, acid, not neutralized polycarboxylic polymers, independently selected from polyacrylic acid, polymethacrylic acid, copolymers of acrylic and methacrylic acid and their mixtures wherein the molecular weight of the polycarboxylic polymer is from 1,000 to 20,000 Dalton, with monofunctional polyethers selected from polyethyleneglycol monomethyl ethers of molecular weight from 2,000 to 13,200 Dalton and difunctional polyethers, selected from polypropyleneglycols of molecular weight from 280 to 11,800 Daltons, in the absence of strong acidic catalysts.

Suitable aqueous suspensions of polymer stabilized ettringite particles are synthesized according to the method described by Lo Presti et al. by combining a water-soluble calcium salt, a water-soluble sulfate salt and a water-soluble aluminium salt in the presence of a water-soluble dispersant, while keeping the pH of the mixture in alkaline conditions with a hydroxide ions source. Water-soluble dispersants that have already been described for the synthesis of transition metal silicate hydrates are suitable for the synthesis of aqueous suspensions of polymer stabilized ettringite, as well. Suitable water-soluble calcium salts include calcium sulfate, calcium hydroxide, calcium nitrate, calcium chloride, calcium formate and calcium acetate and their mixtures. Suitable water-soluble sulfate salts include calcium sulfate and aluminium sulfate and their mixtures. Calcium sulfate can be used as source for both calcium and sulfate ions, while aluminium sulfate can be used as source for both aluminium and sulfate ions. Suitable water-soluble aluminium compounds include aluminium nitrate, sodium aluminate, aluminium citrate, aluminium sulfate and their mixtures. Suitable hydroxide ions source comprises alkali metal hydroxides, alkaline earth metal hydroxides and their mixtures.

Suitable alkanolamines comprise triisopropanolamine (TIPA), triethanolamine (TEA), N,N,N′,N′-tetra(hydroxyethyl)ethylenediamine (THEED), monoethanolamine (MEA), methyldiethanolamine (MDEA), diethanolamine (DEA), diisopropanolamine (DIPA) or their mixtures.

Suitable inorganic accelerators useful for the present invention comprise at least one of the thiocyanate-based compounds, selected from alkali metal thiocyanate, alkaline earth metal thiocyanate or ammonium thiocyanate, sodium nitrate, sodium nitrite, aluminium sulfate or their mixtures.

The hydroxylated organic compounds include carbohydrates, sugar-alcohols, polyols and their mixtures. Suitable carbohydrates include monosaccharides and polysaccharides such as, for example, corn syrup, glucose syrup, molasses, sucrose, inverted sugar, glucose, fructose, maltose and their mixtures. Suitable sugar alcohols include xylitol, mannitol, maltitol, sorbitol, lactitol and their mixtures. Suitable polyols include, for example, glycerol, sodium gluconate, erytritol, pentaerythritol, dipentaerythritol, hexaglycerol, their ethoxylated derivatives and mixtures thereof.

The essential ingredients of the strength enhancing admixture of the invention (transition metal silicate hydrate, ettringite, alkanolamine, hydroxylated organic compound) can be combined in various proportions. The inorganic accelerator may be or not included in the formulation, depending on the chemical nature of the cementitious composition with which the invention is going to be used. Typically, based on the total dry weight of the admixture, the strength enhancing admixture of the invention comprises from 0.5 to 60 weight percent of the transition metal silicate hydrate, from 0.5 to 80 percent of the ettringite, from 1 to 70 weight percent of the alkanolamine, from 0 to 70 weight percent of the inorganic accelerator and from 0.5 to 60 percent of the hydroxylated organic compound.

Typically, the strength enhancing admixture of the invention is in the form of an aqueous suspension, where the different ingredients may be combined in various proportions. The total solids content of the strength enhancing admixture of the invention may be in the range from 10 percent solids to 70 percent solids, depending on the proportions with which the different ingredients are formulated.

The presence of the transition metal bound to the polysilicate chains which constitute the transition metal silicate hydrates of the invention seems to be essential for both the particle size and the viscosity stability over time. In fact, most of the transition metals can easily interact with alkanolamines, alkali thiocyanate and hydroxylated organic derivatives forming stable complexes, as reported by A. Karadag et al. (Polyhedron 20, 2001, pp. 635-641) and by V. T. Yilmaz et al. (Polyhedron 20, 2001, pp. 3209-3217). Such interactions may play an important role in the stabilization process of the strength enhancing admixture of the invention.

The strength enhancing admixtures of the invention are added in an amount from 0.01 to 5% by weight percent on the weight of the cementitious material.

The hydraulic cement in the cementitious composition comprises Portland cement, alumina cement, slag cement, limestone cement, pozzolanic cement, calcined clay cement, sulfoaluminate cement whereas the supplementary cementitious material comprises fly ash, ground limestone, slag, calcined clay, silica fume, natural pozzolan or metakaolin.

The invention is described in further details in the following examples.

### Example 1

This example describes the production of the transition metal silicate hydrate nano-sized aqueous suspension, prepared according to EP 3080052. The product was synthesized by the double precipitation method by combining an aqueous solution of Cu(NO₃)₂ and Ca(NO₃)₂ with a molar ratio Cu/Ca=0.1 (solution A) with an aqueous solution of Na₂SiO₃ (solution B), in the presence of a solution of polycarboxylate dispersant (solution C). The polycarboxylate dispersant was a MPEG-PCE terpolymer of methoxy-polyethyleneglycol-methacrylate of molecular weight of about 5,000 Da, methacrylic acid and polypropyleneglycol-di-methacrylate produced by free radical polymerization according to EP 1547986 B1. The final polymer had a molecular weight of 100,000 Da, as determined by Gel Filtration Chromatography, GFC.

1173 g of a MPEG-PCE aqueous solution (solids content of 7.5 weight percent) (solution C) were placed in a 2 L round-bottom glass reactor equipped with mechanical stirrer and agitated at 300 rpm. Next, 398 g of solution A, containing 1 mole of Ca(NO₃)₂ and 0.1 mole of Cu(NO₃)₂ and 550 g of solution B, containing 1.1 mole of Na₂SiO₃ were simultaneously added to solution C and the whole reaction mass was recycled through a mixing cell equipped with a high shear mixer (Silverson L4R, operated at 8,000 rpm). Solution A and B were added separately by peristaltic pumps at a constant pumping rate within 80 minutes directly in the high shear zone of the mixing cell. The temperature of the reaction was kept constant at 20° C. The final product was a blue aqueous suspension with a viscosity of 215 cP and a dry content of 23 weight percent. The number average particle size of the suspension, determined by Zetasizer Nano series model by Malvern Panalytical Inc., was 89 nm.

### Example 2

This example describes the production of the transition metal silicate hydrate nano-sized aqueous suspension, prepared according to EP 3080052. The product was synthesized by the double precipitation method by combining an aqueous solution of Cu(NO₃)₂ and Ca(NO₃)₂ with a molar ratio Cu/Ca=0.2 (solution A) with an aqueous solution of Na₂SiO₃ (solution B), in the presence of a solution of polycarboxylate dispersant (solution C). The polycarboxylate dispersant was a MPEG-PCE terpolymer of methoxy-polyethyleneglycol-methacrylate of molecular weight of about 5,000 Da, methacrylic acid and polypropyleneglycol-di-methacrylate produced by free radical polymerization according to EP 1547986. The final polymer had a molecular weight of 85,000 Da, as determined by Gel Filtration Chromatography, GFC.

2800 g of a MPEG-PCE aqueous solution (solids content of 3.1 weight percent) (solution C) were placed in a 4 L round-bottom glass reactor equipped with mechanical stirrer and agitated at 300 rpm. Next, 398 g of solution A, containing 1 mole of Ca(NO₃)₂ and 0.2 mole of Cu(NO₃)₂ and 550 g of solution B, containing 1.2 mole of Na₂SiO₃ were simultaneously added to solution C and the whole reaction mass was recycled through a mixing cell equipped with a high shear mixer (Silverson L4R, operated at 8,000 rpm). Solution A and B were added separately by peristaltic pumps at a constant pumping rate within 80 minutes directly in the high shear zone of the mixing cell. The temperature of the reaction was kept constant at 20° C. The final product was a blue aqueous suspension with a viscosity of 185 cP and a dry content of 10 weight percent. The number average particle size of the suspension, determined by Zetasizer Nano series model by Malvern Panalytical Inc., was 76 nm.

### Example 3

This example refers to the synthesis of aqueous suspensions of ettringite particles according to the method described by Lo Presti et al. An aqueous solution of Ca(NO₃) (solution A) and an aqueous solution of Al₂(SO₄)₃ (solution B) were combined in the presence of a solution of polycarboxylate dispersant (solution C) with a Ca/Al molar ratio of 3.1/1. The polycarboxylate dispersant was a MPEG-PCE terpolymer of methoxy-polyethyleneglycol-methacrylate of molecular weight of about 5,000 Da, methacrylic acid and polypropyleneglycol-di-methacrylate produced by free radical polymerization according to EP 1547986 B1 with molecular weight of 100,000 Da, as determined by Gel Filtration Chromatography, GFC.

984 g of a MPEG-PCE aqueous solution (solids content of 14.3 weight percent) (solution C) were placed in a 2 L round-bottom glass reactor equipped with mechanical stirrer and agitated at 300 rpm. Next, 468 g of solution A, containing 1.43 moles of Ca(NO₃), and 290 g of solution B, containing 0.23 moles of Al₂(SO₄)₃, were simultaneously added to solution C and the whole reaction mass was recycled through a mixing cell equipped with a high shear mixer (Silverson L4R, operated at 8,000 rpm). Solution A and B were added separately by peristaltic pumps at a constant pumping rate within 120 minutes directly in the high shear zone of the mixing cell. The temperature of the reaction was kept constant at 20° C. The pH of the solution was kept between 10 and 11 by the addition of a NaOH solution (solution D) added dropwise in the glass reactor via a third peristaltic pump. The final product was a stable white aqueous suspension with a viscosity of 52 cP and a dry content of 26 weight percent. The number average particle size of the suspension, determined by Zetasizer Nano series model by Malvern Panalytical Inc., was 580 nm.

### Example 4

This example refers to the synthesis of aqueous suspensions of ettringite particles according to the method described by Lo Presti et al. conducted at higher pH and with final larger particle size compared to Example 3. An aqueous solution of Ca(NO₃) (solution A) and an aqueous solution of Al₂(SO₄)₃ (solution B) were combined in the presence of a solution of polycarboxylate dispersant (solution C). Ca/Al molar ratio is 3.1/1. The polycarboxylate dispersant was a MPEG-PCE terpolymer of methoxy-polyethyleneglycol-methacrylate of molecular weight of about 5,000 Da, methacrylic acid and polypropyleneglycol-di-methacrylate produced by free radical polymerization according to EP 1547986 B1 with molecular weight of 100,000 Da, as determined by Gel Filtration Chromatography, GFC.

984 g of a MPEG-PCE aqueous solution (solids content of 14.3 weight percent) (solution C) were placed in a 2 L round-bottom glass reactor equipped with mechanical stirrer and agitated at 300 rpm. Next 468 g of solution A, containing 1.43 moles of Ca(NO₃), and 290 g of solution B, containing 0.23 moles of Al₂(SO₄)₃, were simultaneously added to solution C and the whole reaction mass was recycled through a mixing cell equipped with a high shear mixer (Silverson L4R, operated at 8,000 rpm). Solution A and B were added separately by peristaltic pumps at a constant pumping rate within 120 minutes directly in the high shear zone of the mixing cell. The temperature of the reaction was kept constant at 20° C. The pH of the solution was kept between 11 and 12 by addition of a NaOH solution (solution D) added dropwise via a third peristaltic pump in the glass reactor. The final product was a stable white aqueous suspension with a viscosity of 145 cP and a dry content of 26 weight percent. The number average particle size of the suspension, determined by Zetasizer Nano series model by Malvern Panalytical Inc., was 740 nm.

### Example 5

Different formulations of the strength enhancing admixture of the invention were produced by combining the essential ingredients in different proportions. The composition of the formulations is shown in the following Table 1, where the relative amount of each ingredient is indicated as percent by weight (% wt) of the total dry material. The prior art Admixture #1 is based on the same ingredients in their mutual proportions claimed in US 2019/0367422. Admixtures from #2 to #10 are inventive formulations as they all contain ettringite.

The following abbreviations are used:
Ex. 1—Transition metal silicate hydrate (MeSH) synthesized according to Example 1;
Ex. 2—Transition metal silicate hydrate (MeSH) synthesized according to Example 2;
Ex. 3—Ettringite (Ett) synthesized according to Example 3;
Ex. 4—Ettringite (Ett) synthesized according to Example 4;
DEA—Diethanolamine;
TIPA—Triisopropanolamine;
NaSCN—Sodium thiocyanate;
NaNO₃—Sodium nitrate;
Al₂(SO₄)₃—Aluminium sulphate;
S—Sucrose;
GSy—Glucose Syrup;
P—Pentaerythritol;
Sor—Sorbitol;
Gluc—Sodium Gluconate

TABLE 1
Composition of the different formulations of the strength enhancing admixtures of the
invention (#2 to #10) compared with the comparative formulation of the prior art (#1).

| | | | | | | | | | Carbohydrate/ | | Total solids |
|---|---|---|---|---|---|---|---|---|---|---|---|
| | | | | | | | Inorganic | | Polyol/Sugar | | of the final |
| | MeSH | | Ett | | Alkanolamine | | accelerator | | alcohol | | formulation |
| Formulation | Type | % wt | Type | % wt | Type | % wt | Type | % wt | Type | % wt | (%) |
| # 1 | Ex. 1 | 15.3 | — | — | DEA | 15.6 | NaSCN | 36.3 | GSy | 19.6 | 30.0 |
| Comparative | | | — | — | TIPA | 13.2 | | | | | |
| #2 | Ex. 1 | 15.3 | Ex. 3 | 3.1 | DEA | 15.6 | NaSCN | 33.2 | GSy | 19.6 | 30.0 |
| | | | | | TIPA | 13.2 | | | | | |
| #3 | Ex. 1 | 15.3 | Ex. 3 | 10.3 | DEA | 15.6 | NaSCN | 26.0 | GSy | 19.6 | 30.0 |
| | | | | | TIPA | 13.2 | | | | | |
| #4 | Ex.1 | 11.5 | Ex.3 | 25.6 | DEA | 9.6 | NaSCN | 26.8 | GSy | 15.0 | 30.0 |
| | | | | | TIPA | 11.5 | | | | | |
| #5 | Ex. 1 | 10.1 | Ex. 3 | 63.4 | DEA | 12.6 | — | — | GSy | 3.4 | 29.1 |
| | | | | | TIPA | 10.5 | | | | | |
| #6 | Ex. 1 | 10.1 | Ex. 4 | 63.4 | DEA | 12.6 | — | — | Gluc | 3.4 | 29.1 |
| | | | | | TIPA | 10.5 | | | | | |
| #7 | Ex. 1 | 10.1 | Ex. 3 | 52.5 | DEA | 12.6 | Al₂(SO₄)₃ | 11.1 | S | 2.5 | 29.0 |
| | | | | | TIPA | 11.2 | | | | | |
| #8 | Ex. 2 | 10.1 | Ex. 3 | 58.1 | DEA | 12.6 | NaSCN | 5.3 | GSy | 3.4 | 29.1 |
| | | | | | TIPA | 10.5 | | | | | |
| #9 | Ex. 1 | 10.1 | Ex. 3 | 55.8 | DEA | 12.6 | NaSCN | 7.0 | Sor | 4.0 | 29.8 |
| | | | | | TIPA | 10.5 | | | | | |
| #10 | Ex. 1 | 10.1 | Ex. 3 | 54.1 | DEA | 12.6 | NaNO₃ | 5.3 | P | 7.4 | 30.0 |
| | | | | | TIPA | 10.5 | | | | | |

All the formulations were stable on storage.

### Example 6

The ability of the formulations of Example 5 to enhance compressive strength of cementitious compositions was evaluated in mortar tests by using different cementitious binders. All the mortars were prepared according to EN 197-1 norm by mixing normalized sand, the selected binder and predetermined water in a Hobart mixer, in the presence of different dosages of the formulations of the strength enhancing admixtures of the present invention (Table 1 of Example 5). Polycarboxylate PCE superplasticizer Dynamon SX produced by Mapei was always used to impart the desired flowability to the mortars.

The initial consistency of the fresh mortars was measured by the flow table test, after 15 drops. The fresh mortars were molded in three-sector 4×4×16 cm polystyrene formworks and cured at 20° C. and 98% R. H. Compressive strength was measured after 1, 7 and 28 days of curing and compared with reference mortars (REF) not containing the strength enhancing admixtures of Example 5. The dosage of both Dynamon SX PCE superplasticizer and the strength enhancing admixtures of Example 5 are always indicated as percent of dry admixture by mass of cement (% dbmc).

Different binders containing SCMs were used, according to the classification of European Standard EN 197-1:
CEM IVA 42.5N: pozzolanic cement, based on a mixture of clinker (68-89%), pozzolanic material including silica-fume, natural pozzolan, fly ash (11-35%) and gypsum (0-5%);
CEM IVA-P 42.5N: pozzolanic cement, based on a mixture of clinker (68-89%), natural pozzolan, (11-35%) and gypsum (0-5%);
CEM IVB 32.5N: pozzolanic cement, based on a mixture of clinker (45-64%), pozzolanic material including silica-fume, natural pozzolan, fly ash (36-55%) and gypsum (0-5%);
CEM III/B 42.5R: slag cement, based on a mixture of clinker (20-34%), ground granulated blast furnace slag (66-80%) and gypsum (0-5%);
CEM II/A-LL: 42.5R: limestone cement, based on a mixture of clinker (80-94%), limestone (20-6%) and gypsum (0-5%);
CSA: calcium sulphoaluminate cement, based on a mixture of CSA clinker (25-35%), CEM II/A-LL 42.5R (65-45%) and gypsum (10-20%);
Mixture of 75 percent CEM I 52.5R (95-100% clinker and 0-5% gypsum) with 25 percent Class F Fly-Ash, according to ASTM C 618;
LC3: calcined clay cement, based on a mixture of CEM I 52.5R (53%), calcined clay (metakaolin) (29%), limestone (14%) and gypsum (4%).

The results of the mortar tests with the different cements are reported in Table 2.

TABLE 2
Composition of mortars with different cements produced with the formulations of Example
5 (included comparative formulation #1) and relative increase of compressive
strength compared to a reference mortar (REF) not containing such formulations.

| | | | | | | | Strength | | | | |
|---|---|---|---|---|---|---|---|---|---|---|---|
| | Composition of mortars | | | | | | Enhancing | | Relative increase of | | |
| | | | | Dynamon | | | Admixture | | compressive strength | | |
| Type of | Binder | Sand | Water | SX | | Flow | Example 5 | | vs REF (%) | | |
| binder | g | g | g | % dbmc | W/C | mm | Type | % dbmc | 1 d | 7 d | 28 d |
| CEM IVA | 450 | 1350 | 198 | 0.21 | 0.44 | 220 | # 1 | 0.30 | 18.1 | 6.1 | 5.9 |
| 42.5N | 450 | 1350 | 189 | 0.21 | 0.44 | 235 | # 2 | 0.25 | 26.5 | 9.8 | 8.2 |
| | 450 | 1350 | 180 | 0.21 | 0.44 | 238 | # 3 | 0.25 | 30.1 | 15.0 | 9.1 |
| | 450 | 1350 | 180 | 0.21 | 0.44 | 210 | # 7 | 0.25 | 19.0 | 7.2 | 6.0 |
| CEM IVA-P | 450 | 1350 | 207 | 0.21 | 0.46 | 200 | # 1 | 0.30 | 9.8 | 8.7 | 2.7 |
| 42.5N | 450 | 1350 | 207 | 0.21 | 0.46 | 210 | # 4 | 0.25 | 11.8 | 10.7 | 4.6 |
| | 450 | 1350 | 207 | 0.21 | 0.46 | 205 | # 9 | 0.25 | 10.4 | 10.0 | 3.5 |
| CEM IVB | 450 | 1350 | 180 | 0.12 | 0.40 | 210 | # 1 | 0.30 | 15.2 | 19.1 | 10.1 |
| 32.5N | 450 | 1350 | 180 | 0.12 | 0.40 | 220 | # 2 | 0.25 | 21.7 | 25.9 | 11.0 |
| | 450 | 1350 | 180 | 0.12 | 0.40 | 233 | # 3 | 0.25 | 22.7 | 27.0 | 11.9 |
| | 450 | 1350 | 180 | 0.12 | 0.40 | 237 | # 4 | 0.25 | 38.0 | 29.7 | 13.9 |
| | 450 | 1350 | 180 | 0.12 | 0.40 | 218 | # 10 | 0.25 | 16.3 | 19.5 | 10.2 |
| CEM I 52.5R/ | 450 | 1350 | 180 | 0.21 | 0.40 | 215 | # 1 | 0.30 | 10.7 | 5.2 | 4.1 |
| FA (3:1) | 450 | 1350 | 189 | 0.21 | 0.42 | 205 | # 5 | 0.33 | 11.9 | 8.2 | 10.3 |
| CEM IIA-LL | 450 | 1350 | 207 | 0.21 | 0.46 | 210 | # 1 | 0.35 | 4.9 | 4.1 | 4.2 |
| 42.5R | 450 | 1350 | 207 | 0.21 | 0.46 | 218 | # 2 | 0.33 | 15.1 | 12.3 | 7.8 |
| | 450 | 1350 | 207 | 0.21 | 0.46 | 215 | # 3 | 0.33 | 13.1 | 10.1 | 6.4 |
| | 450 | 1350 | 207 | 0.21 | 0.46 | 227 | # 4 | 0.33 | 25.4 | 22.3 | 20.9 |
| | 450 | 1350 | 207 | 0.21 | 0.46 | 207 | # 5 | 0.33 | 37.2 | 30.1 | 26.5 |
| | 450 | 1350 | 207 | 0.21 | 0.46 | 210 | # 6 | 0.33 | 16.2 | 12.4 | 6.9 |
| | 450 | 1350 | 207 | 0.21 | 0.46 | 215 | # 8 | 0.33 | 12.3 | 10.1 | 7.5 |
| | 450 | 1350 | 207 | 0.21 | 0.46 | 215 | # 9 | 0.33 | 10.8 | 14.3 | 15.1 |
| CEM IIIB | 450 | 1350 | 180 | 0.12 | 0.40 | 227 | # 1 | 0.30 | 3.8 | 4.3 | 5.1 |
| 42.5R | 450 | 1350 | 180 | 0.12 | 0.40 | 240 | # 5 | 0.25 | 7.8 | 9.1 | 8.6 |
| CSA | 450 | 1350 | 180 | 0.12 | 0.40 | 198 | # 4 | 0.30 | 9.9 | 7.8 | 5.1 |
| | 450 | 1350 | 180 | 0.12 | 0.40 | 190 | # 5 | 0.30 | 41.9 | 38.7 | 29.1 |
| LC3 | 450 | 1350 | 180 | 0.12 | 0.40 | 210 | # 1 | 0.33 | 12.1 | 10.3 | 8.5 |
| | 450 | 1350 | 180 | 0.12 | 0.40 | 225 | #5 | 0.33 | 22.2 | 24.3 | 24.6 |

The results of the mortar tests clearly show that all the admixtures produce definite relative improvements of the compressive strength at all the dates compared to the reference mortar REF not containing them. Particularly, the admixtures of the invention (formulations from #2 to #10) have been compared to the admixture of the prior art (#1) for all the binders; all the admixtures of the invention produce higher relative strength increase compared to the formulation of prior art #1 with all binders, indicating that the combination of ettringite with metal silicate hydrate plays a fundamental role in improving the compressive strength at any curing time, early and final strength. Moreover, the formulations of the invention are particularly effective in enhancing the strength development of CEM II/A-LL, while the prior art formulation #1 is not effective with this cement.

### Example 7

In this example, concrete tests were performed with and without the strength enhancing admixtures of the invention to verify the strength improvement at different curing times. A mixture of 75 percent Portland cement and 25 percent Fly was used as cementitious binding material.

Concrete specimens were prepared by mixing Type I/II Portland cement according to ASTM C 150 (dosage 267 kg/m³), Class F Fly Ash according to ASTM C 618 (dosage 89 kg/m³), maximum diameter 20 mm coarse aggregates (dosage 1077 kg/m³) and sand (dosage 804 kg/m³).

Dynamon SX superplasticizer produced by Mapei was dosed at 0.47 percent by mass of the total binder (sum of Portland cement and Fly ash) to control the slump flow of concretes in the range from 160 mm to 210 mm (consistency class S4 according to EN 206-1) and to cast concretes with water-to-binder ratio w/b=0.45.

Admixture #3 of the invention was selected for the concrete tests at the dosages of 0.62 and 0.94 percent of admixture by mass of the total binder (sum of Portland cement and fly ash). Its performance was compared to the prior art admixture #1 and was tested at a dosage of 0.62 by mass of total binder (sum of Portland cement and fly ash).

The results of the concrete tests are shown in the following Table 3, which confirm the excellent behavior of the admixture of the invention to enhance the compressive strength of concrete at all curing times, from 1 day to 56 days, and its superiority to the prior art.

Further tests were performed with admixture #5 at the dosage of 0.7, 1.0 and 1.2 percent of admixture by mass of binder (CEM II/A-LL). A comparative example was prepared with comparative formulation #1 at the dosage of 0.8 percent of admixtures by mass of binder. Results are reported in the following Table 4.

Concrete specimens were prepared by mixing CEM II/A-LL type cement according to EN 196-1 (dosage 310 kg/m³), maximum diameter 30 mm coarse aggregates (dosage 1037 kg/m³) and sand (dosage 167 kg/m³).

DynamonCube 800 superplasticizer produced by Mapei was used to control the slump flow of concretes in the range from 210 to 230 mm (consistency class S5 according to EN 206-1) and to cast concretes with water-to-binder ratio w/b=0.57.

The results of Table 4 confirm the excellent behavior of the admixtures of the invention to enhance the compressive strength of concrete at all curing times, from 1 to 28 days. In particular, the data shows the higher compressive strength developed by the admixtures of the invention compared to the concrete containing the comparative admixture #1.

TABLE 3
Results of concrete tests using the strength enhancing admixture #3 of the invention.

| | | | | | | Strength | | | | | | | | | | | | |
|---|---|---|---|---|---|---|---|---|---|---|---|---|---|---|---|---|---|---|
| | Cement | | | | | Enhancing | | | | | | | | | | | | |
| | Type | Fly | Total | | Dynamon | Admixture | | | Compressive strength | | | | | Compressive strength | | | | |
| Mix | I/II | ash | binder | Water | SX | Ex. 5 Table 1 | | | (MPa) | | | | | improvement vs REF (%) | | | | |
| N. | Kg/m³ | Kg/m³ | Kg/m³ | Kg/m³ | % bmb | Type | % bwb | W/B | 1 d | 3 d | 7 d | 28 d | 56 d | 1 d | 3 d | 7 d | 28 d | 56 d |
| REF | 267 | 89 | 356 | 160 | 0.47 | — | — | 0.45 | 15.7 | 27.4 | 31.3 | 38.1 | 42.9 | — | — | — | — | — |
| 1 | 267 | 89 | 356 | 160 | 0.47 | # 3 | 0.62 | 0.45 | 16.8 | 29.9 | 35.3 | 41.8 | 47.0 | 7.0 | 9.1 | 12.8 | 9.1 | 9.6 |
| 2 | 267 | 89 | 356 | 160 | 0.47 | # 3 | 0.94 | 0.45 | 17.1 | 30.5 | 35.5 | 42.7 | 48.0 | 8.9 | 11.3 | 13.4 | 12.1 | 11.9 |
| 3 | 267 | 89 | 356 | 160 | 0.47 | # 1 | 0.62 | 0.45 | 16.2 | 28.9 | 34.5 | 40.9 | 45.4 | 3.2 | 5.5 | 10.2 | 7.3 | 5.9 |

TABLE 4
Results of concrete tests using the strength enhancing admixture #3 of the invention.

| | | | | Strength | | | | | | | | |
|---|---|---|---|---|---|---|---|---|---|---|---|---|
| | Cement | | | Enhancing | | | | | | | | |
| | CEM | | Dynamon | Admixture | | | Compressive strength | | | Compressive strength | | |
| Mix | IIA/A-LL | Water | SX | Ex. 5 Table 1 | | | (MPa) | | | improvement vs REF (%) | | |
| N. | Kg/m³ | Kg/m³ | % bmb | Type | % bmb | W/B | 1 d | 7 d | 28 d | 1 d | 7 d | 28 d |
| REF | 310 | 176 | 0.4 | — | — | 0.57 | 6.7 | 23.5 | 28.6 | — | — | — |
| 1 | 310 | 176 | 0.4 | #3 | 0.7 | 0.57 | 9.5 | 28.8 | 33.7 | 41.8 | 22.6 | 17.8 |
| 2 | 310 | 176 | 0.4 | #3 | 1.0 | 0.57 | 9.7 | 29.9 | 34.2 | 44.8 | 27.2 | 19.6 |
| 3 | 310 | 176 | 0.5 | #3 | 1.2 | 0.57 | 10.9 | 29.1 | 36.4 | 62.7 | 23.8 | 27.2 |
| 4 | 310 | 176 | 0.4 | #1 | 0.8 | 0.57 | 6.5 | 27.9 | 31.1 | −2.9 | 18.7 | 8.7 |

### Example 8

In this example, isothermal calorimeter tests on cement pastes were performed with and without the strength enhancing admixture #5 of the invention during the first 42 hours of hydration. Cement pastes, both the reference sample not containing the inventive admixture and the one containing the inventive admixture #5, contained 1.3 percent by weight of cement of a superplasticizer admixture. A higher cumulative heat development of the hydration reaction, as measured by calorimetric tests, is directly related to a higher degree of hydration of the anhydrous cement. In the experiment, 100 g of a CEM II/A-LL were mixed with 40 g of water, 1.3 g of superplasticizer and 1 g of the strength enhancing admixture #5 of the invention (Table 1 of Example 5). The heat development was monitored by means of a TAM Air isothermal calorimeter during the first 42 hours of hydration. The heat development of a cement paste prepared without any strength enhancing admixture was recorded and used as reference. The dosage of the strength enhancing admixture #5 of Example 5 is indicated as percent of dry admixture by mass of cement (% dbmc).

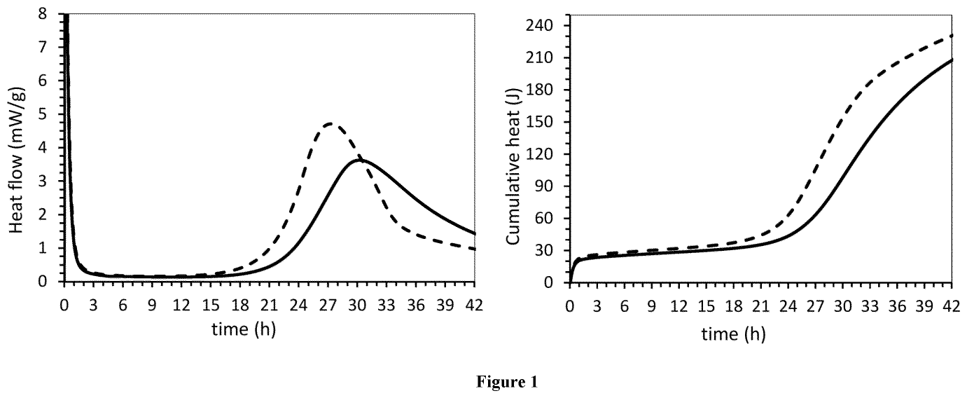

The results of the calorimetric tests with CEM II/A-LL are reported in FIG. 1 wherein heat flow (left graph) and cumulative heat development (right graph) of CEM II/A-LL pastes are shown. Reference (full line), Admixture #5 (0.33% dbwc, dashed line).

It is evident from the example that the addition of the strength enhancing admixtures of the invention selected from Table 1 (#5) enhances the total hydration of the cement paste compared to a sample not containing the strength enhancing admixtures of the invention, as demonstrated by the higher cumulative heat released by cement paste containing the formulation of Table 3. In fact, adding 0.33% dbwc of Admixture #5 to a CEM II/A-LL paste increases the cumulative heat generated by the hydration reaction by more than 11% at 42 hours compared to a reference not containing the inventive admixture.

Furthermore, this calorimetric test demonstrates that admixture #5 is able to accelerate and enhance the hydration reaction of cements even in presence of a superplasticizer. Hence, the admixtures of the invention are fully compatible with a PCE superplasticizer.

1. A strength enhancing admixture for low-carbon cementitious compositions comprising: i) a transition metal silicate hydrate, ii) synthetic ettringite, iii) at least one alkanolamine, and iv) at least one hydroxylated organic compound, wherein the metal transition silicate hydrate has the general formula
aMexOy·bMO·cAl₂O₃·SiO₂·dH₂O 1)
wherein
Me represents a transition metal whose molar coefficient a is in a range between 0.001 and 2, preferably between 0.01 and 1;
M represents an alkaline earth metal whose molar coefficient b is in a range between 0 and 2, preferably between 0.3 and 1.6;
the molar coefficient c for Al₂O₃ is in a range between 0 and 2, preferably between 0.1 and 1;
H₂O represents the hydration water of the silicate hydrate whose molar coefficient d can vary within a wide range between 0.5 and 20;
x and y can both be equal to 1 or different, depending on the valence of the transition metal, given that the valence of the oxygen atom in the metal oxide is equal to 2.

2. The strength enhancing admixture according to claim 1, wherein the transition metal is selected from chromium, manganese, iron, cobalt, nickel, copper and zinc.

3. The strength enhancing admixture according to claim 1, wherein the transition metal silicate hydrate is a mixed silicate hydrate with alkaline earth metals selected from calcium and magnesium.

4. The strength enhancing admixture according to claim 1, wherein the transition metal silicate hydrate is produced by reaction, in alkaline conditions, of a water-soluble silicon-containing compound with a water-soluble transition metal compound and a water-soluble compound of an alkaline earth metal and/or aluminum, the reaction being conducted in the presence of an aqueous solution of a water-soluble dispersant.

5. The strength enhancing admixture according to claim 4, wherein the water-soluble dispersant comprises polycarboxylate ether (PCE) polymer, phosphonate derivatives of polyoxyalkylenes, polynaphthalene sulfonate, polymelamine sulfonate.

6. The strength enhancing admixture according to claim 1, wherein the metal silicate hydrate is in the form of an aqueous suspension of particles with diameter lower than 1,000 nm.

7. The strength enhancing admixture according to claim 1, wherein ettringite is synthesized by reacting a water-soluble calcium compound, a water-soluble sulfate compound, a water-soluble aluminium compound and a water soluble hydroxide ions source, optionally in the presence of a aqueous water-soluble dispersant comprising polycarboxylate ether (PCE) polymer, phosphonate derivatives of polyoxyalkylenes, polynaphthalene sulfonate, polymelamine sulfonate.

8. The strength enhancing admixture according to claim 7 wherein the water-soluble calcium salt for the synthesis of ettringite is selected from calcium sulfate, calcium hydroxide, calcium nitrate, calcium chloride, calcium formate, calcium acetate and their mixtures.

9. The strength enhancing admixture according to claim 8 wherein the water-soluble calcium salt is calcium nitrate.

10. The strength enhancing admixture according to claim 7, wherein the water-soluble sulfate compound is selected from calcium sulfate, aluminium sulfate and their mixtures.

11. The strength enhancing admixture according to claim 7 where the water-soluble aluminium salt is selected from aluminium nitrate, sodium aluminate, aluminium citrate, aluminium sulfate and their mixtures.

12. The strength enhancing admixture according to claim 11 where the water-soluble aluminium salt is aluminium sulfate.

13. The strength enhancing admixture according to claim 7, where the water-soluble hydroxide anions is selected from alkali metal hydroxides, alkaline earth metal hydroxides and their mixtures.

14. The strength enhancing admixture according to claim 13 where the water-soluble hydroxide anion is sodium hydroxide.

15. The strength enhancing admixture according to claim 1, wherein the synthetic ettringite is in the form of an aqueous suspensions of polymer stabilized particles with average particle size lower than 1,000 nm.

16. The strength enhancing admixture according to claim 1, wherein the alkanolamine is selected from triisopropanolamine, triethanolamine, N,N,N′,N′-tetra(hydroxyethyl) ethylenediamine, monoethanolamine, methyldiethanolamine, diethanolamine, diisopropanolamine and their mixtures.

17. The strength enhancing admixture according to claim 1, wherein the hydroxylated organic compound is selected from carbohydrates, sugar-alcohols, polyols and their mixtures.

18. The strength enhancing admixture according to claim 17 wherein the carbohydrate comprises corn syrup, diutan gum, welan gum, molasses, sucrose, glucose, fructose, alkali or alkaline earth gluconate.

19. The strength enhancing admixture according to claim 17 wherein the sugar-alcohol comprises sorbitol, mannitol, maltitol, lactitol and their mixtures.

20. The strength enhancing admixture according to claim 17 wherein the polyol comprises glycerol, erytritol, pentaerythritol, dipentaerythritol, hexaglycerol, their ethoxylated derivatives and their mixtures.

21. The strength enhancing admixture according to claim 1, further containing at least one inorganic accelerator.

22. The strength enhancing admixture according to claim 21 wherein the inorganic accelerator is selected from thiocyanate-based compounds, sulfate-based compounds, aluminate-based compounds, nitrate-based compounds, nitrite-based compounds and their mixtures.

23. The strength enhancing admixture according to claim 1, wherein, based on the total dry weight of the admixture, i) the transition metal silicate hydrate is in an amount of from 0.5 to 60 weight percent, ii) the ettringite aqueous suspension is in an amount from 0.5 to 80 weight percent, iii) the alkanolamine is in an amount of from 1 to 70 weight percent, iv) the hydroxylated organic compound is in an amount of from 0.5 to 60 weight percent and v) the inorganic accelerator is in an amount of from 0 to 70 weight percent.

24. A cementitious composition comprising at least one cementitious material, selected from hydraulic cements and mixtures of hydraulic cements with supplementary cementitious materials, and the strength enhancing admixture of claim 1.

25. The cementitious composition of claim 24, wherein the strength enhancing admixture is added in an amount from 0.01 to 5 weight percent on the weight of the cementitious material.

26. The cementitious composition according to claim 23, wherein the hydraulic cement comprises Portland cement, alumina cement, slag cement, limestone cement, pozzolanic cement, calcined clay cement, sulfoaluminate cement.

27. The cementitious composition according to claim 24, wherein the supplementary cementitious material comprises fly ash, ground limestone, slag, calcined clay, silica fume, natural pozzolan or metakaolin.

28. (canceled)
